(19) United States
(12) Patent Application Publication
(10) Pub. No.: US 2016/0294261 A1
(43) Pub. Date: Oct. 6, 2016

(54) CONTROLLED ASSEMBLY OF PERMANENT MAGNET MACHINES

(71) Applicant: GE Energy Power Conversion Technology Ltd., Warwickshire (GB)

(72) Inventor: Jacob Johannes NIES, Salzbergen (DE)

(21) Appl. No.: 14/679,269

(22) Filed: Apr. 6, 2015

(51) Int. Cl. H02K 15/03

(52) U.S. Cl. CPC H02K 15/03

(57) ABSTRACT

Provided is a control method and a control system for controlling the insertion of a plurality of magnets within an electrical machine including a stator and a rotor which rotates in relation to the stator around a rotary axis, the control system has plurality of sensors which continuously sense an air gap between the rotor and the stator, an encoder which continuously detects an angular position of the rotor, and a processor which receives data from the sensors and the encoder and determines in real-time an insertion order for inserting the plurality of magnets in a surface of the rotor and applies a feedback loop while performing the insertion process to adjust the insertion order based on changes in the data received.

### TECHNICAL FIELD

The technical invention relates generally to controlled assembly of permanent magnet machines (PMMs). In particularly, the invention relates to determining an order for inserting magnets in PMMs or other electrical machines.

### BACKGROUND OF THE INVENTION

In an electrical machine such as a PMM, the magnetic field for the synchronous machine may be provided by using permanent magnets made of neodymium-boron-iron, samarium-cobalt, or ferrite on a rotor of the PMM. In some cases, these magnets are mounted on the surface of the rotor core such that the magnetic field is radially directed across an air gap between the rotor and the stator of the machine. In other cases, the magnetic field is axially directed. Alternatively, the magnets are inset into the rotor core surface or inserted in slots just below the rotor core surface.

FIG. 1 is an expanded view illustrating a rotor surface of a PMM having magnets mounted thereon using a conventional method. As shown in FIG. 1, the rotor surface 1, has a plurality of magnets 3 inserted thereon in predetermined fixed positions using a current insertion method. Using this conventional method, the positions of the magnets 3 are predetermined based on pole numbers 6 and 7, magnet polarity 9, and pole insertion sequence numbers 11, as shown in FIG. 1.

In large electrical machines, the air gap may be inherently diminished by unbalanced magnetic forces. Therefore, the magnets on the rotor and the coils of the stator, opposing each other, may attract each other, therefore causing assembly problems. For example, in an electrical machine where the stator and the rotor are offset, an unwanted force or unbalanced magnetic pull (UMP) may be generated in the direction of the offset. Consequently, the structural stiffness of the electrical machine creates an opposing force in an attempt to react to the unwanted force generated.

The conventional insertion methods fail to dynamically consider the potential offset between the stator and rotor or the unwanted attraction and/or forces (e.g., UMP) which may be generated both during the insertion process and when considering the position in which each magnet is to be inserted.

### SUMMARY OF THE EMBODIMENTS

The various embodiments of the present disclosure are configured to mitigate the disadvantages of the above-mentioned method, by providing a controlled assembly method and a control system for inserting magnets into an electrical machine which applies a feedback loop during the insertion process to adapt to any offset between the rotor and the stator, and to minimize unwanted attraction and/or forces within the electrical machine.

In one exemplary embodiment, a control system is provided for controlling the insertion of a plurality of magnets within an electrical machine including a stator and a rotor which rotates in relation to the stator around a rotary axis, the control system comprises plurality of sensors which continuously measure the air gap between the rotor and the stator, an encoder which continuously detects an angular position of the rotor, and a processor which receives data from the sensors and the encoder and determines in real-time an insertion order for inserting the plurality of magnets in a surface of the rotor and applies a feedback loop while performing the insertion process to adjust the insertion order based on changes in the data received.

According to an embodiment, the spacing of the air gap may be continuously measured; or the air gap may be continuously measured indirectly e.g., by measuring the back side of the rotor rim and subtracting the thickness of the rim.

In another exemplary embodiment, a control method implemented by computer may be provided. The control method comprises performing a feedback loop including inserting at least one magnet in a rotor of the electrical machine, sensing and measuring, via sensors, a spacing of an air gap between the rotor and a stator of the electrical machine, detecting via an encoder, an angular position of the rotor after inserting the at least one magnet, and processing via a processor, measurement data received from the sensors and the encoder, and determining, in real-time, an insertion order for inserting remaining magnets of the plurality of magnets and thus applying the feedback loop while inserting the plurality of magnets.

The foregoing has broadly outlined some of the aspects and features of various embodiments, which should be construed to be merely illustrative of various potential applications of the disclosure. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

### DESCRIPTION OF THE DRAWINGS

FIG. 1 is an expanded view illustrating a rotor surface of an electrical machine, having a plurality of magnets mounted thereon using a conventional insertion method.

FIG. 2 is schematic illustration of an electrical machine for implementing one or more embodiments of the present invention.

FIG. 3 is a schematic illustrating the placement of sensors of the control system for inserting the permanent magnets in a rotor that can be implemented within one or more embodiments of the present invention.

FIG. 4 is a flow diagram illustration a control method including a feedback loop for inserting a plurality of permanent magnets in a rotor of an electrical machine that can be implemented within one or more embodiments of the present invention.

FIG. 5 is an illustration of magnets being inserted on the rotor of an electrical machine that can be implemented within one or more embodiments of the present invention.

FIG. 6 is a schematic illustrating an example of a computer system that can be implemented within one or more embodiments of the present invention.

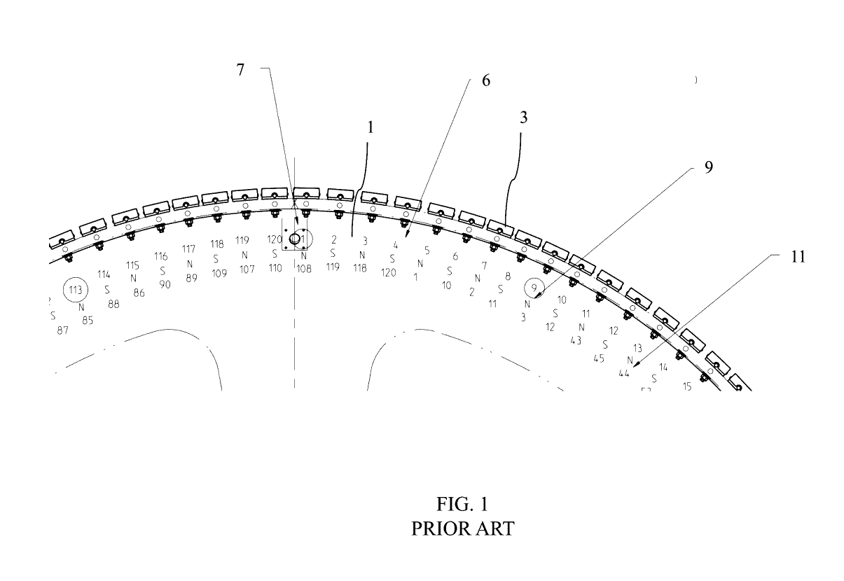

The drawings are only for purposes of illustrating preferred embodiments and are not to be construed as limiting the disclosure. Given the following enabling description of the drawings, the novel aspects of the present disclosure should become evident to a person of ordinary skill in the art. This detailed description uses numerical and letter designations to refer to features in the drawings. Like or similar designations in the drawings and description have been used to refer to like or similar parts of embodiments of the invention.

### DETAILED DESCRIPTION OF THE EMBODIMENTS

As required, detailed embodiments are disclosed herein. It must be understood that the disclosed embodiments are merely exemplary of various and alternative forms. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

The control system and control method according to one or more embodiments of the present invention may be implemented within different electrical machines such as PMMs, permanent magnet generators (PMGs), permanent magnet motors and marine motors, or other suitable electrical machines.

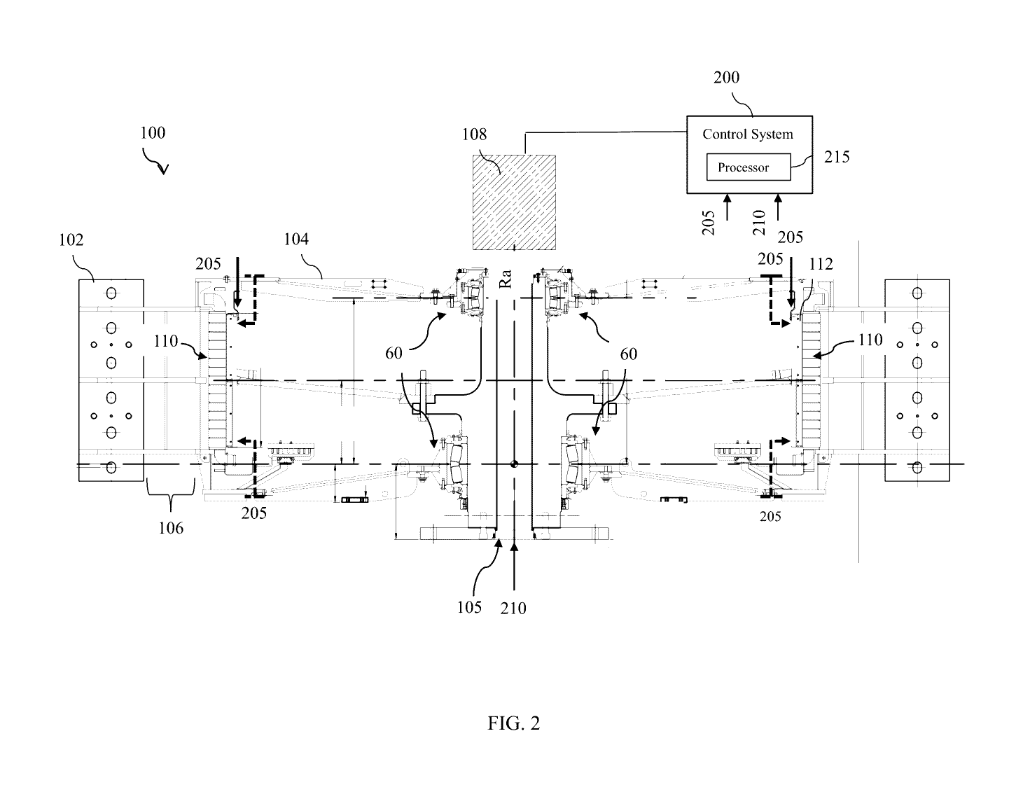

FIG. 2 is a schematic illustration of an electrical machine for implementing one or more embodiments of the present invention. As shown in FIG. 2, the electrical machine 100 inducing a stator 102 and a rotor (e.g., an inner rotor) 104 rotating around a shaft 105 having a dedicated rotary axis Rₐ in relation to the stator 102. The stator 102 may also have a longitudinal axis which aligns with the rotary axis Rₐ of the rotor 104.

Rotation is achieved using bearings 60 as shown. An air gap 106 is located between the inner rotor 104 and the stator 102. An actuator 108 is coupled at the rotary axis Rₐ to facilitate actuation of the rotor 104 in relation to the stator 102. The actuator 108 further controls the radial position of the rotor 104 to the stator 102. The rotor 104 includes a plurality of permanent magnets 110 inserted therein.

The magnets 110 may be inserted into magnet holders (not shown) and mounted on a rotor surface 112, or may be mounted directly on the rotor surface 112 using fastening means (e.g., bolts). If magnet holders are employed, the magnet holders provide a biasing force to secure the magnets 110 therein. The magnet holders may be disposed and divided into sections for ease of handling and installation. The embodiments may be implemented within an electrical machine having an outer stator and an inner rotor as shown. Alternatively, the embodiments can be implemented in an outer rotor having an inner stator or any other type of stator-rotor relationship and is not limited hereto.

A control system 200 according to one or more embodiments of the present invention, comprises a plurality of sensors 205 (e.g., distance sensors) for sensing the spacing and alignment of the air gap 106. The sensors 205 may be disposed in axial positions as indicated by the solid arrows and/or radial positions as indicated by the dashed arrows near the rotor surface 112 of the rotor 104. Alternatively, the sensors 205 may be mounted on the stator 102 or in between the rotor 104 and the stator 102. Alternatively, the sensors may measure other quantities like strain or force.

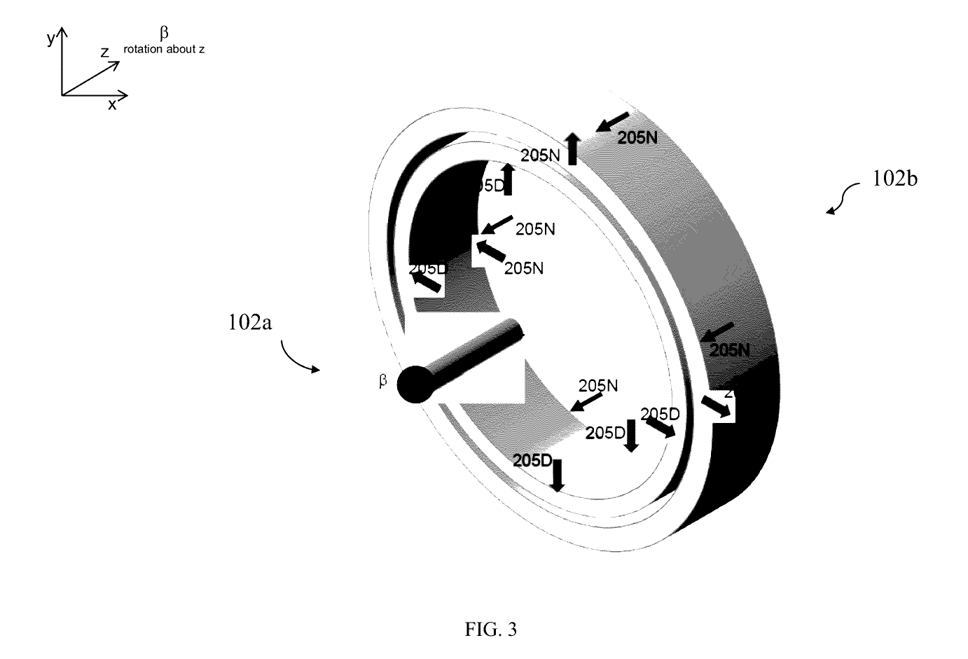

The sensors 205 may be disposed on a driven side 102a or a non-driven side 102b (as depicted in FIG. 3) of the stator 102. The sensors 205 are connected and controlled by the control system 200 to measure the spacing of the air gap 106 and determine structural stiffness of the electrical machine 100 in multiple directions. According to one or more embodiments, the sensors 205 continuously monitor the movement of the rotor 104 in relation to the stator 102 to determine changes in movement and may optionally determine stiffness of the electrical machine 100.

Reflectors may be attached at points around the stator 102 on the driven and non-driven faces for measuring the stator face dimensions. According to other embodiments, proximity probes (e.g., capacitive, inductive, or optical) may be employed. Light transmission through the air gap 106, from the driven side of the stator 102 using a light emitting element (e.g., a light emitting diode (LED)), may be measured with a photodetector. The photodetector can be controlled by the control system 200 to measure the spacing of the air gap 106.

In yet other embodiments, laser reflection off the rotor 104 may be monitored using a laser fixed to a surface to emit at a low incident angle from the driven side of the stator 102. Measurements of a position of a laser spot, on the non-driven side 102b, after one or more laser reflections are detected within the air gap 106, may be obtained. Besides the contact-less devices listed above, measurement devices with a spring-loaded pin may be used to determine the relative position between rotor and stator.

The control system 200 further includes an encoder 210 located at the shaft 105 to detect an angular position of the rotor 104 relative to the stator 102 while inserting the plurality of magnets 110 in the rotor 104. By definition, the angular position defines which magnet position on the rotor 104 is in front of the magnet insertion bay or location and the distance away from it. The encoder 210 may be an absolute encoder or any other type of encoder suitable for the purposes set forth herein.

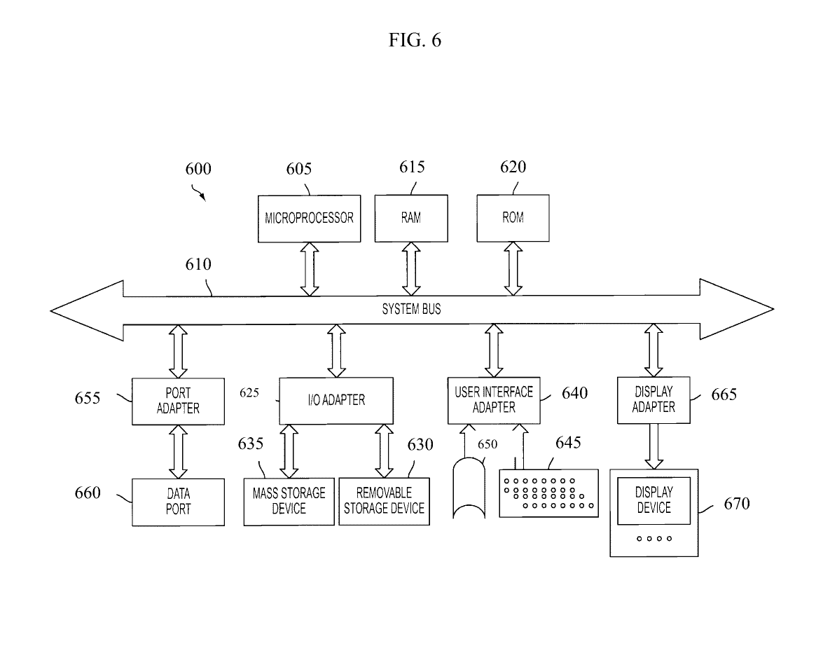

The control system 200 also includes a processor 215 (605 as depicted in FIG. 6, for example), or data processing unit (DPU), for receiving the measurements detected by the sensors 205 and the encoder 210 and processing them.

An insertion mechanism (not shown) is also provided for performing the insertion of the magnets 110 in the rotor 104. The insertion mechanism is arranged at a location which is accessible, for example, a three, six or nine o'clock position depending on where the loading of the magnets 110 is best supported by scaffolding and logistics of the magnets. The insertion mechanism may be further controlled by the processor 605.

The processor 215, in accordance with the embodiments, further performs a technique to determine, in real-time, an insertion order for inserting the plurality of magnets 110 in the rotor surface 112 of the rotor 104. The technique of the embodiments is responsive to measurement data received from the sensors 205, the encoder 210, and the placement of at least one magnet 110 in the rotor 104. The processor 215 applies a feedback loop for adjusting the insertion order in real-time to control insertion of the plurality of magnets 110 in the rotor 104 (e.g., at the rotor surface 112).

For example, after inserting 4 or 5 magnets 110, based on actual displacement measurements, spacing of the air gap, information of already-mounted magnets and their position, and additional measurement data received in real-time at the processor 215, the processor 215 can adjust the insertion order to offset unwanted forces (e.g., UMP). This adjustment is accomplished by applying magnets 110 at an opposing side of the rotor 104. The processor 215 repeats the feedback loop until all of the plurality of magnets 110 have been inserted in the rotor 104.

The measurement data can be displayed, and is viewable to user, at a display device (e.g., 670 as depicted in FIG. 6) of the control system 200.

Based on the measurement data received, the control system 200 may consider several variables when determining the insertion order. These variables can include, for example, magnet-to-magnet variation of strength in magnetic attraction, nonlinearity of the magnetic attraction verses any offsets, bearing clearances, deviations in structural stiffness and tolerances on machine parts and assembly thereof. As understood to one of skill in the art, other suitable variables can be used and would be within the spirit and scope of the present invention.

According to one or more embodiments, the control system 200 can determine the insertion order based on historical data stored in a storage device (e.g., 635 shown in FIG. 6) therein. The historical data can include data associated with magnet type, recorded UMPs, or recorded distances between rotor and stator and any other type of historical data.

FIG. 3 is a schematic illustrating the placement of sensors of the control system for inserting the permanent magnets on the rotor, according to the embodiments. As shown in FIG. 3, the stator 102 is disposed and includes the driven side 102a which is a front side facing the rotor 104 and the non-driven side 102b, which is a rear or outer side of the stator 102. A plurality of sensors 205 can be disposed in various directions along the x, y, and z axes, as indicated by the respective arrows for driven-side sensors 205D and nondriven-side sensors 205N. There may be symmetrical and non-symmetrical machines, both in length direction as well as non-symmetry in circumferential directions (e.g., with a stator 102 lower half having feet to connect to a foundation and the stator 102 top half mounted on a top of the lower half without foundation attachment).

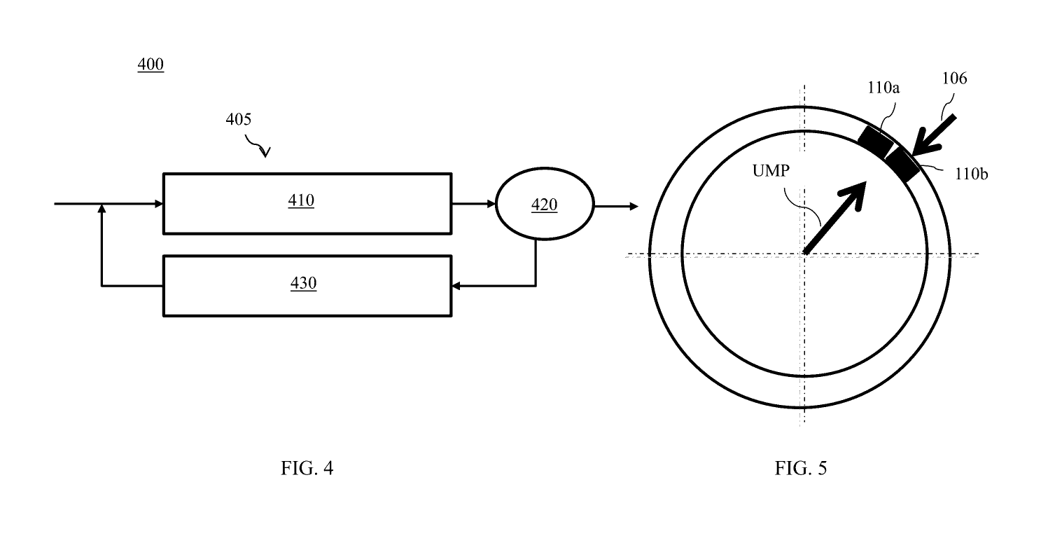

A control method for inserting the magnets 110 in the rotor 104 is described below, with reference to FIGS. 4 and 5.

FIG. 4 is a flow diagram illustration a control method comprising a feedback loop for inserting a plurality of magnets on the rotor of the electrical machine, according to the embodiments. As shown in FIG. 4, the method 400 performs a feedback loop 405 that begins at operation 410 where the control system 200 controls the insertion mechanism to insert at least one magnet 110 in the rotor 104.

The process then continues to operation 420 where the sensors 205 sense and measure the spacing of the air gap 106 between the rotor 104 and the stator 102. Other measurements are also performed, such as structural stiffness in multiple directions, e.g. by exerting a known force into the system determining the response to the applied force, thus determining the stiffness. As a variant of that, the system may prescribe one or more magnet configurations that have known levels of unbalanced magnetic pull, that will be rotated around in order to observe the system response in several directions. Further, in operation 420, the encoder 210 continuously detects an angular position of the rotor 104, and the insertion position of each inserted magnet 110. The process continues to operation 430.

In operation 430 the control system 200 receives the measurement data from the sensors 205 and the encoder 210. The processing unit 215 processes the measurement data and defines an insertion order best suited for inserted the remaining magnets 110 of the plurality of magnets. That is, the control system 200 reads the sensors 205, calculates the next sequence of insertion, and informs the operator of the insertion mechanism which magnet to insert next in the sequence. The control system 200 may further control actuation e.g., the rotation of the rotor 104 between two insertions or motion of the magnet into its insertion position.

The control system 200 performs the feedback loop 405 in real-time such that the insertion order may be adjusted (i.e., re-calculated) during the insertion process. This process facilitates adapting to any changes in movement of the rotor 104 and the stator 102, relative to each other, and any changes in structural stiffness in multiple directions of the electrical machine 100.

The feedback loop can be repeated, depending on the continuous monitoring of the spacing of the air gap 106, and the insertion positions already filled with magnets 110. According to the embodiments, the feedback loop can be set to occur at different intervals of time, or as otherwise desired by a user of the control system 200.

In the illustrious embodiments, the insertion order can be determined after rotating the rotor 104 at least one revolution and then measuring the spacing (or distance) of the air gap 106 to determine any closure or stiffness of the air gap 106 relative to the stator 102. By determining the structural stiffness and the measured air gap 106, an optimum insertion order for inserting the magnets 110 may be determined As noted above, the system may prescribe one or more magnet configurations that have a known levels of unbalanced magnetic pull that will be rotated around in order to observe the system response in several directions. The optimization can be focused on a minimum amount of rotation between magnet insertion, a minimum amount of air gap closure, a minimum overall assembly time, other factors, or a combination thereof.

FIG. 5 is an illustration of magnets mounted on the rotor that can be implemented within one or more embodiments of the present invention. In FIG. 5, the rotor 104 is shown with two magnets 110a and 110b inserted therein and the forces of the UMP and the actual measured air gap 106 opposing each other. The control system 200 takes into account the UMP and the measured air gap 106 to determine and adjust the insertion order during the insertion process of the magnets 110a and 110b.

FIG. 6 is a schematic illustrating an example of a computer system that can be implemented within one or more embodiments of the present invention. The control system 200 may be implemented within the computer system 600 as shown in FIG. 6. The computer system 600 includes at least one microprocessor or central processing unit (CPU) 605.

The CPU 605 is interconnected via a system bus 610 to a random access memory (RAM) 615, a read-only memory (ROM) 620, and an input/output (I/O) adapter 625. The I/O 625 connects a removable data and/or program storage device 630. Also included are a mass data and/or program storage device 635, a user interface adapter 640 for connecting a keyboard 645 and a mouse 650, a port adapter 655 for connecting a data port 660, and a display adapter 665 for connecting a display device 670.

The ROM 620 contains the basic operating system for the computer system 600. The operating system may alternatively reside in the RAM 615 or elsewhere, as is known in the art. Examples or removable data and/or program storage device 630 include magnetic media such as floppy drives and tape drives and optical media such as CD ROM drives.

Examples of mass data and/or program storage device 635 include hard disk drives and non-volatile memory, such as flash memory. In addition to the keyboard 645 and the mouse 650, other user input devices such as trackballs, writing tablets, pressure pads, microphones, light pens, and position sensing screen displays may be connected to user the user interface 640. Examples of display devices include cathode-ray tubes (CRT) and liquid crystal displays (LCD).

Signals from sensor 205 and the encoder 210 (as shown in FIG. 2) are input into the data port 660 shown.

The display device 670 may display proposed and alternative insertion schemes, a summary of decision data on insertion schemes, estimated time(s) to complete the magnet insertions, margin to maximum applied UMP, estimated deformations, graphical and tabular indications of direct measured values or raw data, geometrical re-calculation of such raw data being calibrated (offset), shown in different coordinate systems (angles instead of linear displacements), calculated or measured forces.

A computer program with an appropriate application interface may be created by one of skill in the art and stored on the system or a data and/or program storage device to simplify the practicing the embodiments. In operation, information for or the computer program, created to execute the embodiments, is loaded on the appropriate removable data and/or program storage device 630. The information is fed through data port 660, or typed in using the keyboard 645.

In view of the above, the present method embodiment may therefore take the form of a computer or controller implemented processes and apparatuses for practicing those processes. This disclosure can also be embodied in the form of computer program code containing instructions embodied in tangible media, such as floppy diskettes, CD ROMs, hard drives, or any other computer-readable storage medium, wherein, when the computer program code is loaded into and executed by a computer or controller, the computer becomes an apparatus for practicing the embodiments.

This disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention.

When implemented on a general-purpose microprocessor, the computer program code segments configure the microprocessor to create specific logic circuits. A technical effect of the executable instructions is to implement the exemplary method described above.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A control system for inserting a plurality of magnets within an electrical machine, the control system comprising:
a plurality of sensors configured to continuously sense an air gap between a rotor and a stator of the electrical machine; and
a processor configured to process data received from the plurality of sensors after at least one magnet has been inserted, and to determine in real-time, an insertion order for inserting the plurality of magnets;
wherein the control system performs a feedback loop during the insertion process; and
wherein the insertion order is adjusted based on changes in the data received.

2. The control system of claim 1, further comprising an encoder configured to continuously detect an angular position of the rotor, wherein the processor further determines the insertion process based on the detected angular position.

3. The control system of claim 1, wherein the plurality of sensors are disposed at axial and/or radial positions along a surface of the rotor and comprise a sensing direction along x, y and z axes.

4. The control system of claim 1, wherein the plurality of sensors are disposed at a driven side and/or a non-driven side of the stator and comprise a sensing direction along x, y and z axes.

5. The control system of claim 2, wherein the encoder is further configured to detect an insertion position of the at least one magnet after insertion.

6. The control system of claim 1, wherein the plurality of sensors are further configured to determine structural stiffness of the electrical machine in multiple directions.

7. The control system of claim 2, wherein the encoder is an absolute encoder.

8. The control system of claim 1, wherein the feedback loop is repeatedly applied in real-time, to adjust the insertion order for inserting the plurality of magnets during the insertion process.

9. The control system of claim 1, wherein the processor is further configured to determine the insertion order based on historical data and current measured data.

10. A control method to be implemented by computer including a feedback loop comprising:
inserting at least one magnet in a rotor of the electrical machine;
continuously sensing, via sensors, an air gap between the rotor and a stator of the electrical machine after inserting the at least one magnet; and
processing via a processor, data received from the sensors and determining, in
real-time, an insertion order for inserting remaining magnets of the plurality of magnets, and applying the feedback loop while inserting the plurality of magnets.

11. The control method of claim 10, further comprises repeating the feedback loop at different time intervals.

12. The control method of claim 10, further comprises initially determining the insertion order after rotating the rotor at least one revolution and measuring a spacing of the air gap.

13. The control method of claim 10, further comprising:
continuously detecting via an encoder, an angular position of the rotor, and adjusting the insertion process based on the angular position detected.

14. The control method of claim 13, further comprising:
detecting, via the encoder, an insertion position of the at least one magnet after insertion.

15. The control method of claim 10, comprising:
repeatedly performing the feedback loop in real-time, to adjust the insertion order during the insertion process in order to adapt to any changes in movement of the rotor and the stator relative to each other.

16. The control method of claim 10, further comprising:
determining, via the plurality of sensors, structural stiffness of the electrical machine in multiple directions.

17. The control method of claim 10, further comprising:
determining, via the processor, the insertion order based on historical data and current measured data.

18. A computer program product for implementing a control method including a feedback loop for inserting a plurality of magnets in an electrical machine, by computer, comprising:
inserting at least one magnet in a rotor of the electrical machine;
continuously sensing, via sensors, an air gap between the rotor and a stator of the electrical machine after inserting the at least one magnet; and
processing via a processor, data received from the sensors and determining, in
real-time, an insertion order for inserting remaining magnets of the plurality of magnets, and applying the feedback loop while inserting the plurality of magnets.

19. The computer program product of claim 18, wherein the feedback loop further comprises:
continuously detecting via an encoder, an angular position of the rotor, and adjusting the insertion process based on the angular position detected.

20. The computer program method of claim 18, wherein the feedback loop further comprises:
repeatedly performing the feedback loop in real-time, to adjust the insertion order during the insertion process in order to adapt to any changes in movement of the rotor and the stator relative to each other.
